(19) United States
(12) Patent Application Publication
(10) Pub. No.: US 2016/0146849 A1
(43) Pub. Date: May 26, 2016

(54) Resin-Sealed Sensor Device

(71) Applicant: HITACHI AUTOMOTIVE SYSTEMS, LTD., Ibaraki (JP)

(72) Inventors: Akihiro YAGUCHI, Hitachinaka-shi, Ibaraki (JP); Masahide HAYASHI, Hitachinaka-shi, Ibaraki (JP)

(73) Assignee: Hitachi Automotive Systems ,Ltd.

(21) Appl. No.: 14/899,263

(22) PCT Filed: Feb. 5, 2014
(86) PCT No.: PCT/JP2014/052603

§ 371 Date: Dec. 17, 2015

(30) Foreign Application Priority Data
Jun. 20, 2013 (JP) 2013-129448

(51) Int. Cl. G01P 15/08; G01P 15/18

(52) U.S. Cl. CPC G01P 15/0802; G01P 15/18

(57) ABSTRACT

To provide a resin-sealed sensor device in which a sensor element that detects an inertial force such as acceleration or angular velocity is mounted on a pad, and the entire thereof is molded by resin, the resin-sealed sensor device with a high reliability by suppressing or resolving a sensor output error by reducing or resolving inclination or deformation of the sensor element or the pad at the time of resin injection, in a resin-sealed sensor device 100 including: a circuit unit 10 that includes a sensor element 1 for detection of a physical quantity, a semiconductor chip 2, a pad 3 of which shape in a plan view has any shape among a rectangle, a circle and an ellipse, and supported leads 5A to 5D and an outer conductor lead 4 to be connected to the pad 3; and a molded resin body 20 that seals the circuit unit 10, each of the supported leads 5A to 5D is arranged in each divided regions to be formed by dividing the shape into four virtual regions when an intersection point O between two axes L1 and L2, perpendicular to each other, is set to match a central point of the shape of the pad 3.

### TECHNICAL FIELD

The present invention relates to a resin-sealed inertial force sensor device in which a sensor element such as an inertial force sensor in which one inertial force sensor that detects acceleration or angular velocity, or a plurality of detection units of acceleration or angular velocity are complexly provided, and a semiconductor chip on which the sensor element is mounted are resin-sealed by transfer molding or the like to form a package.

### BACKGROUND ART

Recently, sensor devices to detect various types of physical quantities have been developed in automobiles, agricultural machines, construction machines and the like in order for stable control of vehicle attitude, improvement in safety or improvement in workability.

In particular, application of an acceleration sensor or an angular velocity sensor in the automobiles has been increased for control of equipment (for example, airbag) in order to prevent sideslip and improve safety of passenger.

In addition, the sensor device is also assumed to be mounted in an engine room when being applied to the automobiles, and thus, the sensor device needs to withstand a severe environmental load such as a thermal change or mechanical vibration, and further, it is indispensable for the sensor device itself to be small in order to be mountable in a limited space.

In addition, an inertial force sensor is used for a posture control (for example, a horizontal control) of ancillary machines to be connected in the agricultural machines or the construction machines, in order to implement stable work on a sloping land or the like.

A detection means of using micro electro mechanical systems (MEMS) of silicon (Si) has been the mainstream in the acceleration sensor or the angular velocity sensor to be mounted to various types of the sensor devices described above in order for reduction in size, multi-functionality, complexity, and further productivity improvement. A physical quantity such as acceleration or angular velocity is detected by forming a fine pectinate structural body of silicon using the micro electro mechanical system technique, and converting micro displacement of the pectinate structural body into an electrical signal.

A sensor device in a mode in which a sensor is mounted on a semiconductor chip (for example, an LSI substrate) that processes a signal from the sensor and controls input and output of the signal with respect to the outside, these sensor and semiconductor chip are mounted to a pad (tab), a lead that performs transmission of an electrical signal with respect to the outside is connected to the pad, and then, the above-described members are sealed by resin to forma package, has been well-known as a mode of the sensor device provided with the inertial force sensor (the acceleration sensor or the angular velocity sensor) produced by the MEMS technique.

In the sensor device having such a mode, the pad and the lead are formed in an integrated manner as a lead frame, and after the formation of the package using the resin, the lead is provided as an inner lead inside the package and an outer lead that protrudes to the outside of the package. Meanwhile, the pad is held by the lead frame using a supported lead. Incidentally, a resin-sealed package by a transfer molding method is generally used when packaging the inertial force sensor using the resin.

In the packaging using the transfer molding, the semiconductor chip and the inertial force sensor element are mounted onto the pad via an adhesive (including an adhesive film such as a die attach film (DAF)), and after the attachment, the inertial force sensor element and the semiconductor chip, and the semiconductor chip and the inner lead are electrically connected to each other using a thin metal wire (wire). Thereafter, this assembly is placed inside a molding die, resin is injected from an end of the die, and then, the resin-sealed package is formed when the resin is cured. After forming the package, an unnecessary part such as an outer frame of the lead frame other than the outer lead is cut and removed, and the outer lead is processed to have a predetermined shape, thereby manufacturing the resin-sealed sensor device.

However, there is a case in which unbalance is caused in a resin flow due to arrangement of a sensor element or the semiconductor chip inside the package, or a shape of the inner lead in such resin sealing using the transfer molding.

This unbalance in the resin flow causes distribution in pressure generated by the resin flow which acts on a surface of the sensor element or the semiconductor chip, and the pad fluctuates in a vertical direction (thickness direction of the member) when the supported lead does not withstand such pressure distribution. This fluctuation causes the resin to be cured and to be packaged in a state in which the sensor element is inclined from a horizontal angle in some cases.

When the inertial force sensor element of the acceleration or the angular velocity is implemented in the inclined state from the horizontal angle, a sensor output is reduced by the amount of an inclined angle thereof (reduced by 1/cos θ when the inclined angle is θ), which becomes an output error that is a factor to inhibit stability of the sensor.

Sensor devices considering prevention of the inclination of the sensor element in the transfer molded package is disclosed in PTLs 1 and 2.

In a sensor device disclosed in PTL 1, a plurality of supported leads for holding a sensor are formed respectively in a pair of two sides of a semiconductor chip having a rectangular shape in a plan view.

Meanwhile, a semiconductor device disclosed in PTL 2 describes a mode in which one supported lead is formed in each of a pair of two sides, which oppose each other, of a die pad having a rectangular shape in a plan view on which a sensor chip and a controller chip are mounted, and a mode in which a supported lead is additionally formed in one side between the other pair of two sides (the mode in which the die pad is suspended using the three supported leads in total).

### CITATION LIST

### Patent Literatures

PTL 1: JP 2013-44524 A

PTL 2: JP 2010-177510 A

### SUMMARY OF INVENTION

### Technical Problem

Since the two supported leads are formed to respectively support the pair of two sides of the semiconductor chip having the rectangular shape in the plan view in the sensor device disclosed in PTL 1, a resistive force acts on deformation in a suspension direction thereof. However, the other pair of sides other than faces on which the supported leads are formed are not supported by the supported lead, and thus, the resistive force with respect to deformation in the pair of sides or deformation in a direction defined by the pair of sides is deficient to be insufficient to prevent deformation of the semiconductor chip. Thus, there is a high possibility that an error caused by deformation of the sensor becomes a problem in a case in which a vehicle body control or an attitude control of ancillary equipment with high accuracy is implemented using a sensor output.

Such a problem similarly occurs in the semiconductor device described in PTL 2 in which only the pair of two opposing sides of the die pad having the rectangular shape in the plan view, or the three sides are supported by the supported leads. In a case in which the three sides of the die pad are suspended respectively by the supported leads, it is difficult to control deformation or inclination, at the time of resin injection, of the other side which is not suspended by the supported lead, and it is difficult to resolve the output error caused by inclination or the like of the sensor chip. However, an object of causing the die pad to be suspended by the supported lead in PTL 2 is to completely fill a cavity with resin and not to suppress the inclination or the like of the sensor element at the time of resin injection as described above. Thus, it is considered that it is possible to sufficiently achieve the object listed in PTL 2 even with the mode in which the two sides or the three sides of the die pad are suspended by the supported leads.

The present invention has been made in view of the above-described problems, and an object thereof is to provide a resin-sealed sensor device in which a sensor element that detects an inertial force such as acceleration or angular velocity is mounted onto a pad, and the entire configuration is molded using resin, the resin-sealed sensor device that suppresses or resolves an sensor output error with a high reliability by reducing or resolving inclination or deformation of the sensor element or the pad at the time of resin injection.

### Solution to Problem

To achieve the object, a resin-sealed sensor device includes, a circuit unit including a sensor element for detection of a physical quantity, a semiconductor chip on which the sensor element is mounted, a pad on which the semiconductor chip is mounted and of which shape in a plan view has any shape among a rectangle, a circle and an ellipse, and supported leads and an outer conductor lead to be connected to the pad; and a molded resin body that seals the circuit unit, wherein each of the supported leads is arranged in each divided region to be formed by dividing the shape into four virtual regions when an intersection point between two axes perpendicular to each other is set to match a central point of the any shape of the pad.

### Advantageous Effects of Invention

According to a resin-sealed sensor device of the present invention, a pad on which a sensor element and a semiconductor chip are mounted has any shape in a plan view in a rectangle, a circle or an ellipse, and supported leads are arranged in four divided regions to be formed when an intersection point between two axes perpendicular to each other is set to match a central point of the shape of the pad. Accordingly, the highly reliable resin-sealed sensor device is provided which is capable of suppressing or resolving deformation or inclination of a circuit unit including the sensor element, the semiconductor chip and the pad at the time of resin injection, and thus, suppressing a sensor output error.

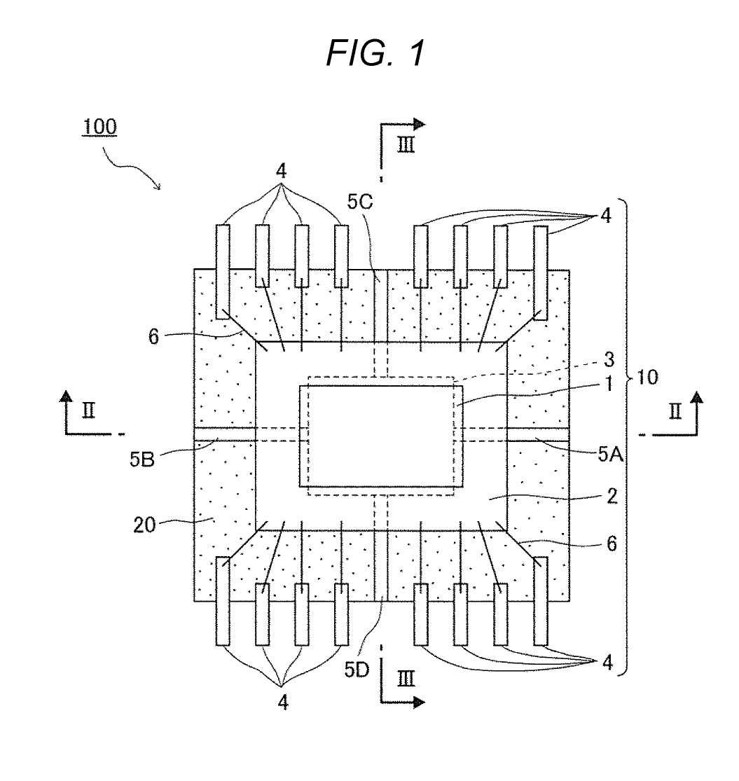

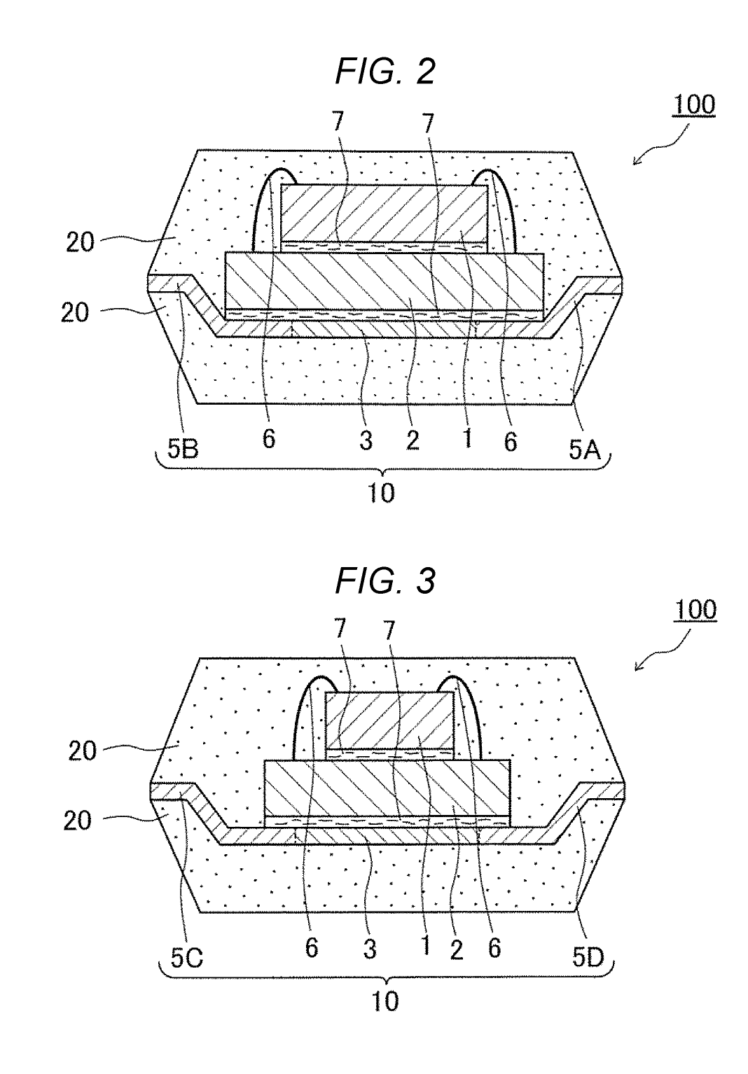

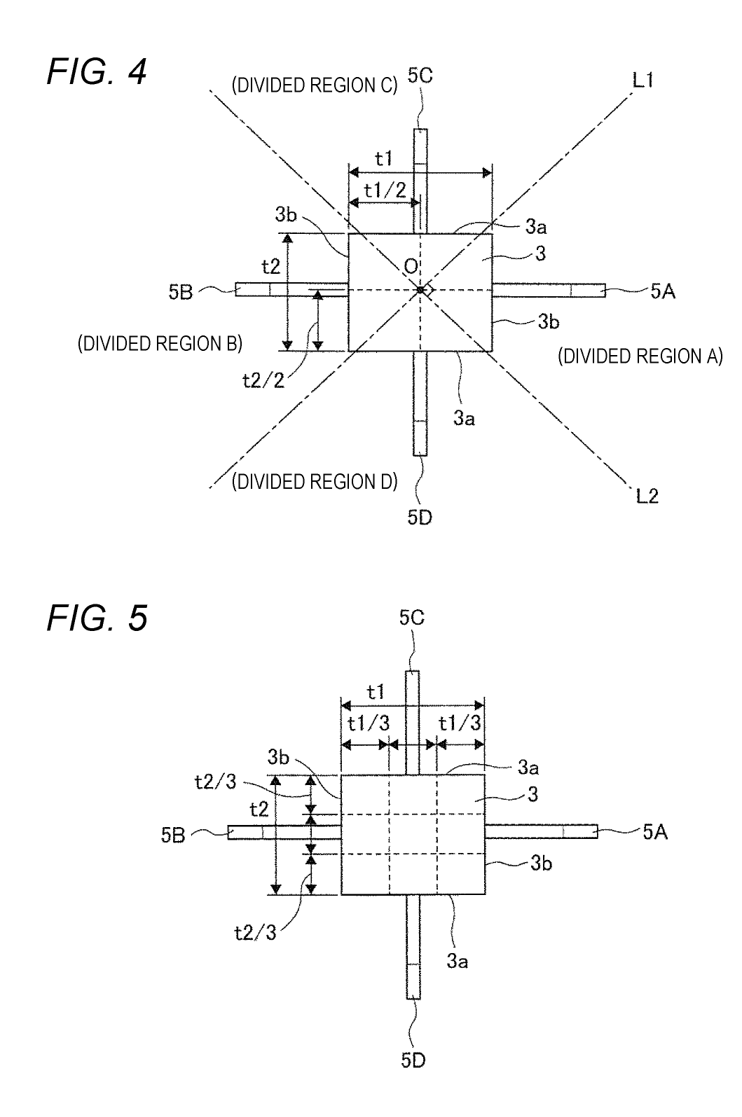

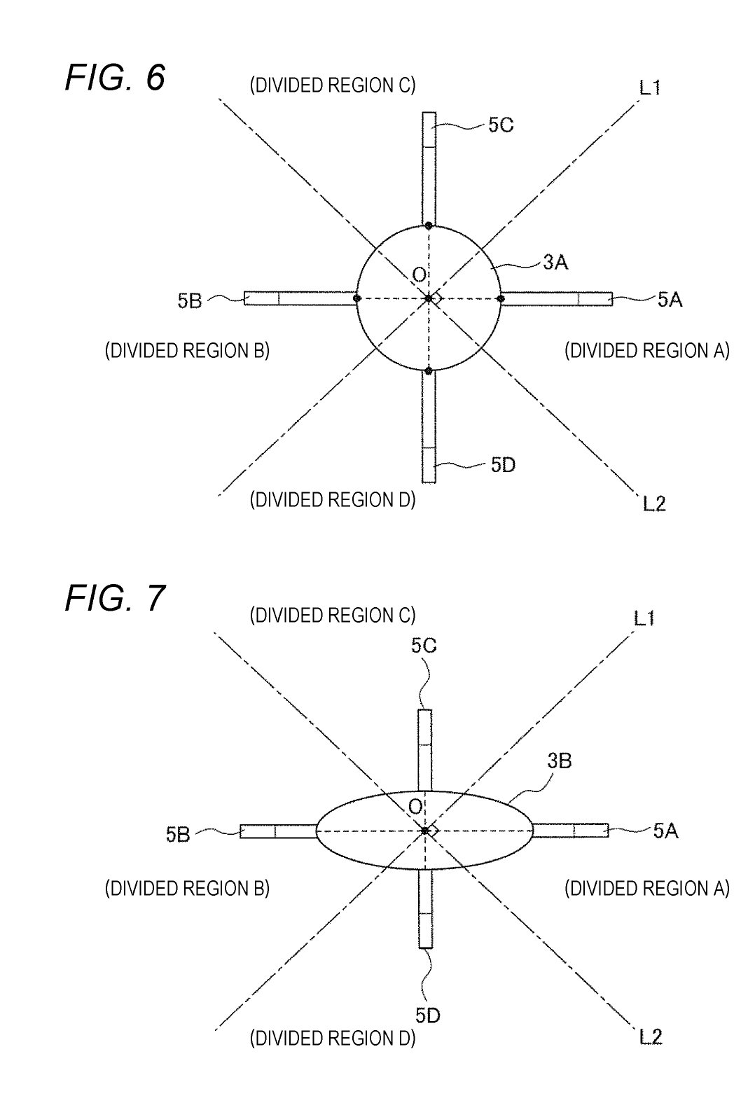

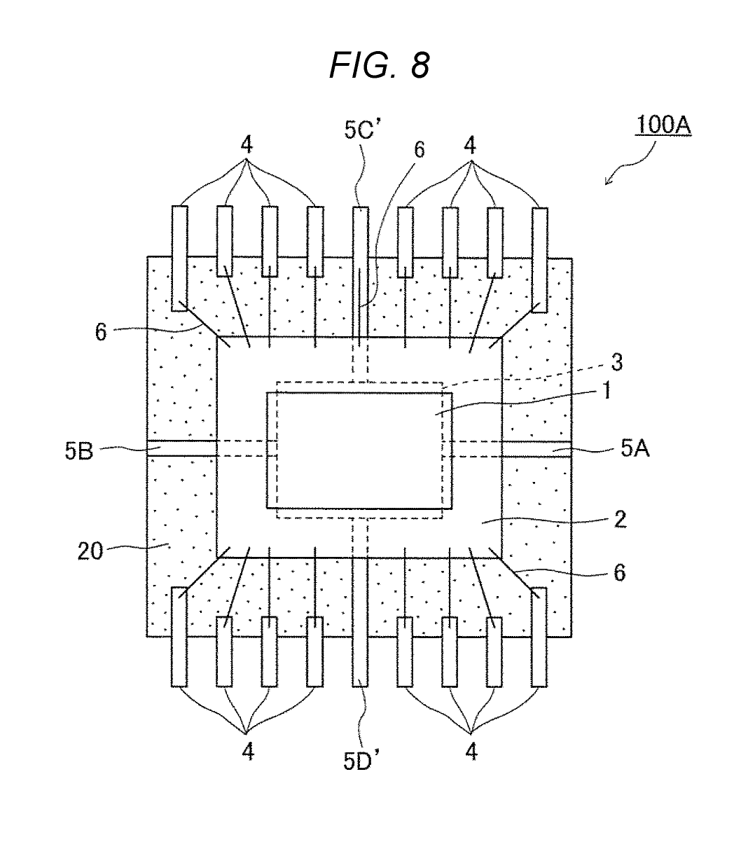

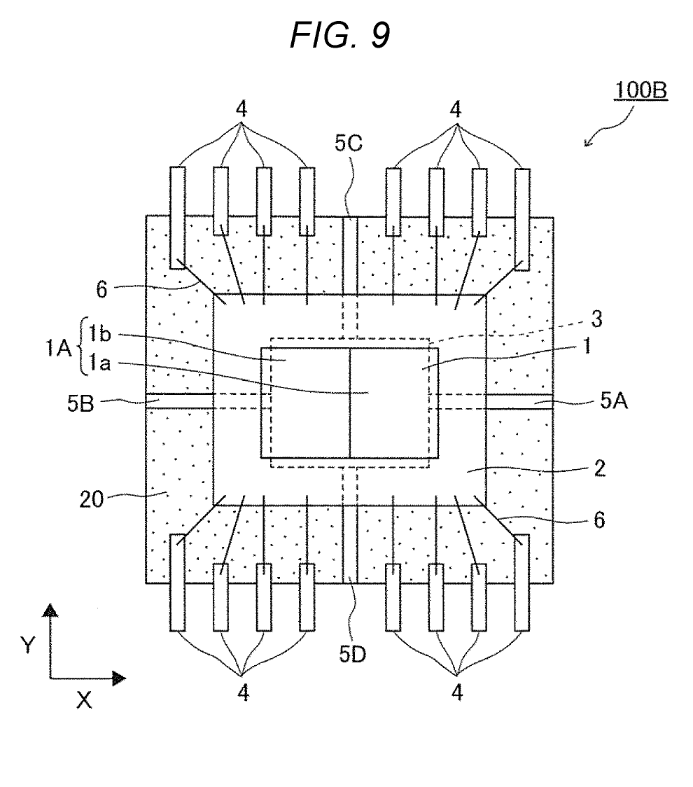

### BRIEF DESCRIPTION OF DRAWINGS

[FIG. 1] FIG. 1 is a plan view according to Embodiment 1 of a resin-sealed sensor device of the present invention, and a diagram illustrating an interior by removing a molded resin body at an upper side.

[FIG. 2] FIG. 2 is a view taken along arrow II-II of FIG. 1.

[FIG. 3] FIG. 3 is a view taken along arrow III-III of FIG. 1.

[FIG. 4] FIG. 4 is a plan view according to Embodiment 1 of a pad and a supported lead.

[FIG. 5] FIG. 5 is a plan view according to Embodiment 2 of the pad and the supported lead.

[FIG. 6] FIG. 6 is a plan view according to Embodiment 3 of the pad and the supported lead.

[FIG. 7] FIG. 7 is a plan view according to Embodiment 4 of the pad and the supported lead.

[FIG. 8] FIG. 8 is a plan view according to Embodiment 2 of the resin-sealed sensor device of the present invention, and a diagram illustrating an interior by removing the molded resin body at the upper side.

[FIG. 9] FIG. 9 is a plan view according to Embodiment 3 of the resin-sealed sensor device of the present invention, and a diagram illustrating an interior by removing the molded resin body at the upper side.

### DESCRIPTION OF EMBODIMENTS

Hereinafter, a description will be given regarding embodiments of a resin-sealed sensor device of the present invention with reference to the drawings.

### Embodiment 1 of Resin-Sealed Sensor Device

<Regarding Resin-Sealed Sensor Device>

FIG. 1 is a plan view according to Embodiment 1 of a resin-sealed sensor device of the present invention, and a diagram illustrating an interior by removing a molded resin body at an upper side; FIG. 2 is a view taken along arrow II-II of FIG. 1, and a cross-sectional view in a long-side direction of the device; and FIG. 3 is a view taken along arrow III-III of FIG. 1, and a cross-sectional view in a short-side direction of the device.

A resin-sealed sensor device 100 illustrated in FIG. 1 is configured roughly by a circuit unit 10 including a sensor element 1 for detection of a physical quantity such as an inertial force (acceleration or angular velocity), a semiconductor chip 2 (also referred to as a semiconductor element) on which the sensor element 1 is mounted, a pad 3 (also referred to as a die pad, a chip pad, a tab or the like) on which the semiconductor chip 2 is mounted and of which shape in a plan view is a rectangle (rectangular shape), supported leads 5A, 5B, 5C and 5D and an outer conductor lead 4 to be connected to the pad 3, and a molded resin body 20 that seals the circuit unit 10.

The sensor element 1 and the semiconductor chip 2, and the semiconductor chip 2 and the pad 3 are connected to each other by a paste-like or film like adhesive material 7.

An electrode (not illustrated) provided on an upper surface of the sensor element 1 and an electrode (not illustrated) provided on an upper surface of the semiconductor chip 2 are electrically connected to each other by a wire 6, and similarly, the electrode of the semiconductor chip 2 and the outer conductor lead 4 are also electrically connected to each other by a wire 6.

The entire outer conductor lead 4 includes an inner lead to be electrically connected to the semiconductor chip 2 inside the molded resin body 20, and an outer lead to be connected to a mounting substrate or a casing (not illustrated) at the outside being integrally formed.

A physical quantity detection unit which is formed by microfabrication of silicon (Si) and has a pectinate shape is built in the sensor element 1, and a periphery thereof is sealed by stacking Si or glass. A mode in which an acceleration sensor or an angular velocity sensor is singly provided or a mode in which these sensors are complexly provided in plural is applied as the sensor element 1.

The semiconductor chip 2 is obtained by forming a predetermined fine circuit or an electrode on Si using a semiconductor process processing technique. The semiconductor chip 2 controls a detection operation of the sensor element 1, and also performs control or the like to input or output a detection signal from the sensor element 1 inside or outside the device 100.

The pad 3, the outer conductor lead 4 and the supported leads 5A to 5D are formed in an integrated manner using the same material, and configure a lead frame as a whole in a stage prior to formation of the molded resin body 20. Incidentally, “connection” between the pad and the supported lead in the present specification means not only that the both are formed in the integrated manner using the same material as above, but also that the both are formed as different members using heterologous materials and integrated through a connection process.

The pad 3, the outer conductor lead 4 and the supported leads 5A to 5D that configure the lead frame are made of a metal material such as copper (Cu) or an alloy thereof, or an iron-nickel alloy (Fe-42Ni and the like).

The wire 6 uses a fine wire made of gold (Au) having a diameter of 20 to 25 μm, for example.

The molded resin body 20 is made of a thermosetting resin (epoxy resin) filled with silica particles, for example.

Both materials with conductivity and without conductivity can be applied as the adhesive material 7 that connects the sensor element 1 and the semiconductor chip 2, and the semiconductor chip 2 and the pad 3, and a paste-like or film-like adhesive material having a silicone resin, an epoxy resin or a polyimide resin as a main component is applied in a case in which the conductivity is not required. On the other hand, in a case in which the conductivity is required, a paste-like or film-like adhesive material filled with silver (Ag) particles is applied. Among them, the film-like adhesive material 7 allows an even thickness after bonding the members, and thus, it is possible to suppress a variation (variation in levelness) of a mounting position of each member, and it is possible to expect an effect of reducing a variation in output of the sensor element 1.

In the example illustrated in the drawings, each shape in the plan view of the sensor element 1, the semiconductor chip 2, the pad 3 and the molded resin body 20 is a rectangle (rectangular shape). Incidentally, these shapes in the plan view are not limited to the rectangle, but may be a square, a circle, an ellipse and the like. In addition, the rectangular shape and the square include a shape of which corners are chamfered and curved.

Here, a description will be given regarding a method of manufacturing the resin-sealed sensor device 100.

Prior to transfer molding, the circuit unit 10 is assembled by assembling the sensor element 1, the semiconductor chip 2, the pad 3, the supported leads 5A to 5D, and the outer conductor lead 4, and electrically connecting the sensor element 1 and the semiconductor chip 2, and the semiconductor chip 2 and the outer conductor lead 4 by the wire 6.

The produced circuit unit 10 is placed inside a molding die provided with cavities (not illustrated) with a predetermined shape, and at this time, the supported leads 5A to 5D are fixed to respective four sides of the die so that the circuit unit 10 is suspended inside the cavities.

In such a state, resin is injected into the cavity from an end of the die, and the molded resin body 20 is formed to enclose the circuit unit 10 when the resin is cured.

An unnecessary part such as an outer frame of the lead frame other than the outer lead is cut and removed after the molded resin body 20 is formed, and the outer lead is processed to have a predetermined shape, thereby manufacturing the resin-sealed sensor device 100 illustrated in the drawings.

The supported leads 5A to 5D are configured to achieve action of holding a planar attitude and suppressing deformation of the circuit unit 10 suspended inside the die with respect to resin pressure of the resin injected into the cavity at the time of formation of the molded resin body 20.

Next, a description will be given regarding embodiments of the pad and the supported lead hereinafter.

### Embodiment 1 of Pad and Supported Lead

FIG. 4 illustrates an embodiment of the pad 3 and the supported leads 5A to 5D that configure the resin-sealed sensor device 100 illustrated in FIG. 1.

In the pad 3 and the supported leads 5A to 5D according to a mode illustrated in FIG. 4, a shape of the pad 3 in the plan view is a rectangle (rectangular shape), and the supported leads 5A to 5D are connected to each midpoint of two pairs of long sides 3a (having a length t1), and short sides 3b (having a length t2).

Further, these four supported leads 5A to 5D are present in respective four virtual divided regions A to D to be formed when an intersection point O between two axes L1 and L2, which are perpendicular to each other, is set to match a center of the rectangular pad 3.

Further, the four supported leads 5A to 5D extend in a direction to be perpendicular to each side at each midpoint of the sides of the pad 3.

Meanwhile, the present inventors have conducted an experiment to calculate the amount of defection as follows. To be specific, a pad having a rectangular plane in a size of 5 mm×3 mm, a thickness of 0.15 mm and made of a copper material is produced, and each maximum deflection amount is measured in a case in which a uniformly distributed load of 0.5 MPa is loaded onto the pad in a state in which the pad is supported by each midpoint of sides of the pad, and in a case in which the same uniformly distributed load is loaded in a state in which the same pad is supported at each corner of the pad.

As a result of the measurement, the maximum deflection amount in a case in which the pad was supported at each midpoint of the sides was 16 μm while the maximum deflection amount in a case in which the pad was supported by each corner was 164 μm so that there was a difference by about 10 times.

From such a result of verification, it is understood that there is a mode in which it is possible to effectively reduce deformation or deflection with respect to the load to be applied while increasing rigidity of the pad by allowing the pad to be supported by the supported lead at each midpoint of sides in the pad 3 and the supported leads 5A to 5D of the mode illustrated in FIG. 4.

Incidentally, it is possible to sufficiently expect the effect of reducing the deformation or the deflection even in a mode in which the supported lead is arranged not to be perpendicular but to be inclined with respect to each side although not illustrated.

### Embodiment 2 of Pad and Supported Lead

Meanwhile, FIG. 5 is a plan view according to Embodiment 2 of the pad and the supported lead. In this mode, each of the long sides 3a and the short sides 3b is divided trisected, each range of ⅓ at the center is set to a central region, and the supported leads 5A to 5D are respectively arranged inside the respective central regions.

Incidentally, the setting of the central region is not limited to the central region when each side is trisected, but can be set to an appropriate range in which it is possible to effectively suppress the deformation or the deflection of the pad when the supported lead is arranged in terms of planar dimensions of the pad, a relation of thickness and a relation with the acting load, and also can be set to a central region in which each side is divided into five equal parts, or a central region in which each side is divided into seven equal parts.

### Embodiment 3 of Pad and Supported Lead

FIG. 6 is a plan view of Embodiment 3 of the pad and the supported lead. In this mode, the four supported leads 5A to 5D are arranged with respect to a pad 3A having a circular shape in the plan view at four points at which two diameters perpendicular to each other and the circle intersect one another.

Even in this mode, these four supported leads 5A to 5D are present in the four virtual divided regions A to D to be formed when the intersection point O between the two axes L1 and L2, which are perpendicular to each other, is set to match a center of the circular pad 3A.

It is possible to expect the effect of reducing the deformation and the deflection of the pad, and it is possible to expect the action capable of holding a horizontal attitude of the pad with respect to the acting resin pressure also by the pad and the supported lead of the mode illustrated in FIG. 6.

### Embodiment 4 of Pad and Supported Lead

FIG. 7 is a plan view of Embodiment 4 of the pad and the supported lead. In this mode, the four supported leads 5A to 5D are arranged with respect to a pad 3B having an elliptical shape in the plan view at four points at which a long axis and a short axis of the ellipse and the ellipse intersect one another.

Even in this mode, these four supported leads 5A to 5D are present in the four virtual divided regions A to D to be formed when the intersection point O between the two axes L1 and L2, which are perpendicular to each other, is set to match a center of the elliptical pad 3B.

It is possible to expect the effect of reducing the deformation and the deflection of the pad, and it is possible to expect the action capable of holding a horizontal attitude of the pad with respect to the acting resin pressure also by the pad and the supported lead of the mode illustrated in FIG. 7.

### Embodiment 2 of Resin-Sealed Sensor Device

Next, a description will be given regarding Embodiment 2 of the resin-sealed sensor device. Here, FIG. 8 is a plan view of Embodiment 2 of the resin-sealed sensor device of the present invention, and a diagram illustrating an interior by removing the molded resin body at an upper side.

A configuration of a resin-sealed sensor device 100A illustrated in FIG. 8 different from the resin-sealed sensor device 100 illustrated in FIG. 1 is that each of supported leads 5C′ and 5D′, present at each long side, extends outside the molded resin body 20 and acts as an outer conductor lead.

Further, any one of the supported leads 5C′ and 5D′ is a supported lead also serving as a signal lead, and is electrically connected to the sensor element 1 and the semiconductor chip 2 via the wire 6, which is also different. FIG. 8 illustrates an example in which the supported lead 5C′ is connected to the semiconductor chip 2 via the wire 6.

When a part of the supported leads is used as the outer conductor lead, it is not necessary to provide the supported lead that supports the pad 3 as a different body from the outer conductor lead, and thus, it is possible to decrease a space at the long side in the example illustrated in FIG. 8. Further, it is possible to reduce a size of the resin-sealed sensor device 100A than the resin-sealed sensor device 100, which also contributes to reduction in size of a printed board or equipment on which the resin-sealed sensor device 100A is mounted.

Further, since the supported leads 5C′ and 5D′ includes the outer leads, it is possible to expect heat dissipation action therefrom. That is, it is possible to release heat generated by operation of the semiconductor chip 2, via the pad 3, from the supported leads 5C′ and 5D′ to the outside of the resin-sealed sensor device 100A, which leads to improvement of a heat dissipation property of the device.

Incidentally, not only one of the supported leads 5C′ and 5D′ but also both the leads may be the supported leads also serving as the signal leads.

In addition, the supported lead also serving as the signal lead may be connected to a ground terminal outside the resin-sealed sensor device 100A, and accordingly, it is possible to reduce noise to be superimposed onto the output signal of the resin-sealed sensor device 100A. Incidentally, in this case, it is possible to achieve strengthening of resistance with respect to the noise by allowing the entire lower surface of the semiconductor chip 2 to be connected to the external ground terminal.

### Embodiment 3 of Resin-Sealed Sensor Device

Next, a description will be given regarding Embodiment 3 of the resin-sealed sensor device. Here, FIG. 9 is a plan view of Embodiment 3 of the resin-sealed sensor device of the present invention, and a diagram illustrating an interior by removing the molded resin body at the upper side.

A configuration of a resin-sealed sensor device 100B illustrated in FIG. 9 is different from that of the resin-sealed sensor device 100 illustrated in FIG. 1 in that a sensor element 1A includes biaxial acceleration sensor elements 1a and 1b which have detection sensitivity in an X-axis direction and a Y-axis direction. Another difference is that the four supported leads 5A to 5D include a pair of two supported leads having the X-axis direction as a stretching direction and another pair of two supported leads having the Y-axis direction, perpendicular to the X-axis direction, as the stretching direction, and the stretching directions of the supported leads 5A to 5D and the detection-axis directions according to the biaxial acceleration sensor elements 1a and 1b are matched.

When there is inclination in each detection-axis direction of the sensor elements 1a and 1b, there is a risk of generating a severe output fluctuation depending on an inclination angle. When the supported leads 5A to 5D are provided in a direction to be set to match an output axis of the sensor as illustrated in FIG. 9, it is possible to suppress the deformation or inclination of the pad 3 on which the acceleration sensor elements 1a and 1b are mounted in the detection-axis direction, which leads to suppression of the output fluctuation of the sensor elements 1a and 1b.

Incidentally, although the biaxial acceleration sensor elements 1a and 1b are integrated to configure the sensor element 1A in the example illustrated in FIG. 9, the acceleration sensor elements 1a and 1b may be provided as different bodies and be mounted on the semiconductor chip in the state of being separated (not illustrated).

In such a mode in which the acceleration sensor elements 1a and 1b are mounted at separated positions as the different bodies, it is possible to mount the elements to each part which hardly receives influence caused by expansion and contraction of the molded resin body 20 or deformation of the entire resin-sealed sensor device.

Further, a triaxial sensor element in which an acceleration sensor element in a Z-axis direction is added to the biaxial acceleration sensor may be implemented, or a sensor element in which the acceleration sensor and the angular velocity sensor are combined may be implemented.

### REFERENCE SIGNS LIST

1, 1A sensor element
2 semiconductor chip (semiconductor element)
3, 3A, 3B pad
4 outer conductor lead
5A, 5B, 5C, 5C′, 5D, 5D′ supported lead
6 wire
7 adhesive material
10 circuit unit
20 molded resin body
100, 100A, 100B resin-sealed sensor device
L1, L2 two axes perpendicular to each other

1. A resin-sealed sensor device comprising:
a circuit unit including
a sensor element for detection of a physical quantity,
a semiconductor chip on which the sensor element is mounted,
a pad on which the semiconductor chip is mounted and of which shape in a plan view has any shape among a rectangle, a circle and an ellipse, and
supported leads and an outer conductor lead to be connected to the pad; and
a molded resin body that seals the circuit unit,
wherein each of the supported leads is arranged in each divided region to be formed by dividing the shape into four virtual regions when an intersection point between two axes perpendicular to each other is set to match a central point of the any shape of the pad.

2. The resin-sealed sensor device according to claim 1,
wherein the shape in the plan view of the pad is the rectangle, and the supported leads are arranged in respective central regions of four sides of the rectangle.

3. The resin-sealed sensor device according to claim 2,
wherein the supported leads are arranged at respective midpoints of the four sides of the rectangle.

4. The resin-sealed sensor device according to claim 3,
wherein the supported leads are perpendicular to the respective sides at the respective midpoints of the four sides of the rectangle.

5. The resin-sealed sensor device according to claim 1,
wherein at least one of the supported leads serves also as the outer conductor lead.

6. The resin-sealed sensor device according to claim 1,
wherein a stretching direction of the supported lead and a detection-axis direction of the sensor element are matched.

7. The resin-sealed sensor device according to claim 6,
wherein the supported leads are configured in four including a pair of two supported leads having an X-axis direction as the stretching direction, and another pair of two supported leads having an Y-axis direction, perpendicular to the X-axis direction, as the stretching direction, and
the sensor element is a biaxial acceleration sensor element having detection sensitivity in the X-axis direction and the Y-axis direction.

8. The resin-sealed sensor device according to claim 1,
wherein the shape in the plan view of the pad is the circle, and the supported leads are arranged in four at four points at which two diameters, perpendicular to each other, and the circle intersect one another.

9. The resin-sealed sensor device according to claim 1,
wherein the shape in the plan view of the pad is the ellipse, and the supported leads are arranged in four at four points at which a long axis and a short axis of the ellipse and the ellipse intersect one another.
